(19) United States
(12) Patent Application Publication
(10) Pub. No.: US 2009/0063527 A1
(43) Pub. Date: Mar. 5, 2009

(54) PROCESSING OF DATABASE STATEMENTS WITH JOIN PREDICATES ON RANGE-PARTITIONED TABLES

(75) Inventors: Vincent CORVINELLI, Mississauga (CA); John F. HORNIBROOK, Markham (CA)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 11/849,247

(22) Filed: Aug. 31, 2007

(51) Int. Cl. G06F 7/14; G06F 17/30

(52) U.S. Cl. 707/101; 707/E17.002

(57) ABSTRACT

A method for processing database statements with join predicates on range-partitioned tables is provided. The method provides for receiving a database statement with a join predicate between a first table and a second table for processing, responsive to the join predicate involving one or more leading columns of a partition key for the first table, a nested-loop join operation being selected to join the first table and the second table, the first table being an outer table of the nested-loop join operation, and data from the second table being piped, calculating maximum and minimum join key values for the second table, creating a partition elimination bitmap for the first table based on the maximum and minimum join key values of the second table, and pushing the partition elimination bitmap onto a scan of the first table to exclude one or more partitions of the first table from the scan.

### FIELD OF THE INVENTION

The present invention relates generally to processing of database statements with join predicates on range-partitioned tables.

### BACKGROUND OF THE INVENTION

With a range-partitioned table, if a database statement includes a predicate on a partitioning column, then it may be possible to exclude one or more partitions of the table from processing of the database statement, which would save time and resources. Elimination of partitions from database statement processing when join predicates are involved, however, has been limited. In particular, a partition of a range-partitioned table can only be eliminated from processing of a database statement with a join predicate on a partitioning column of the range-partitioned table when a nested-loop join operation is selected for optimization of the database statement and the range-partitioned table is designated as the inner table of the nested-loop join operation. Hence, if another type of join operation (e.g., a sort-merge join operation, a hash join operation, or the like) is selected for optimization of the database statement or if the range-partitioned table is designated as the outer table of the nested-loop join operation, then partition elimination would not be possible.

### SUMMARY OF THE INVENTION

A method for processing database statements with join predicates on range-partitioned tables is provided. The method provides for receiving a database statement for processing, the database statement comprising a join predicate between a first table and a second table, the first table being a range-partitioned table that is partitioned based on values in a partition key of the first table, the partition key of the first table being one or more columns of the first table, responsive to the join predicate involving one or more leading columns of the partition key for the first table, determining whether a nested-loop join operation, a sort-merge join operation, or a hash join operations has been selected to join the first table and the second table, responsive to a nested-loop join operation being selected to join the first table and the second table, determining whether the first table is an outer table or an inner table of the nested-loop join operation, responsive to the first table being the outer table of the nested-loop join operation, determining whether data from the second table is piped, responsive to data from the second table being piped, calculating a maximum value and a minimum value for a join key of the second table, the join key of the second table being one or more columns of the second table involved in the join predicate, creating a partition elimination bitmap for the first table based on the maximum value and the minimum value calculated for the join key of the second table, the partition elimination bitmap including a bit for each partition in the first table, a value of each bit in the partition elimination bitmap denoting whether the partition in the first table corresponding to the bit is to be scanned or not, and pushing the partition elimination bitmap created for the first table onto a scan of the first table to exclude one or more partitions of the first table from the scan.

### BRIEF DESCRIPTION OF THE DRAWINGS

FIGS. 1A-1F depict a process for processing database statements with join predicates on range-partitioned tables according to an implementation of the invention.

FIGS. 2A-2D illustrate graphical representations of different types of sort-merge join operations.

FIG. 3 shows a system for processing database statements with join predicates on range-partitioned tables according to an implementation of the invention.

FIG. 4 is a block diagram of a data processing system with which implementations of the invention can be implemented.

### DETAILED DESCRIPTION

The present invention generally relates to processing of database statements with join predicates on range-partitioned tables. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

Range-partitioned tables are tables that are partitioned based on values in one or more columns. The term partitioning key is sometimes used to reference the one or more columns on which partitioning of a range-partitioned table is based. Each partition of a range-partitioned table includes rows in which values of the partitioning key for the range-partitioned table are within a pre-defined range.

For range-partitioned tables, database statement predicates that are on a partitioning column may be used to exclude certain partition(s) of the range-partitioned tables from database statement processing. This will lead to savings in time and resources. As an example, suppose a table ‘dp’ is created as follows:

```
create table dp (a int, b int, c int) partition by (a)
(PART p1 starting (0) ending (100),
    PART p2 starting (101) ending (200),
    PART p3 starting (201) ending (300),
    PART p4 starting (301) ending (400),
    PART p5 starting (401) ending (500));
```

Based on the table definition, table ‘dp’ includes five partitions. Suppose a database statement set forth below is received for processing:

select *
from dp
where a > 50 and a < 150;

The database statement includes two predicates, “a>50” and “a<150”. Based on these two predicates, only partitions “p1” and “p2” will need to be scanned because the other partitions “p3”, “p4”, and “p5” will not contain any data that will satisfy the two predicates in the database statement. As a result, partitions “p3”, “p4”, and “p5” can be excluded from processing of the database statement. The process of excluding partitions from consideration in database statement processing based on predicates is sometimes referred to as partition elimination or data partition elimination.

With join predicates, however, partition elimination has been limited. Currently, when a database statement includes a join predicate on a partitioning key of a range-partitioned table, partition elimination is only available if a nested-loop join operation is selected for the join and the range-partitioned table is designated as an inner table of the nested-loop join operation because the join predicate can be pushed on (e.g., applied to) the inner table access.

For example, suppose another database statement set forth below is received for processing:

select *
from dp, t
where dp.a = t.a;

The database statement includes a join predicate “dp.a=t.a”. Also, suppose that column ‘a’ of table ‘t’ only contains values in the range of 50 to 250. Thus, only partitions “p1”, “p2”, and “p3” of table ‘dp’ will need to be scanned as the other two partitions “p1” and “p2” will not contain any data that will satisfy the join predicate.

If a database system processing the database statement chooses to join tables ‘dp’ and ‘t’ using a nested-loop join operation with table ‘dp’ as an inner table of the nested-loop join operation, then data partition elimination can be performed by pushing the join predicate onto the scan of table ‘dp’. Thus, as each row of the outer table is retrieved, all rows of the inner table need not be scanned if the join predicate is pushed onto the scan of the inner table.

However, if the database system chooses to join tables ‘dp’ and ‘t’ using a nested-loop join operation with table ‘dp’ as an outer table of the nested-loop join operation, then a full scan of table ‘dp’ will be required. Likewise, if the database system optimizer chooses to join tables ‘dp’ and ‘t’ using another type of join operation, such as a sort-merge join operation, a hash join operation, and so forth, then the join predicate cannot be pushed onto the scans of table ‘dp’ and as a result, a full scan of table ‘dp’ will be required.

A list of terminology used throughout the following description is provided below.
outer table of a join—in a graphical representation of the join, the outer table is the table on the left
inner table of a join—in a graphical representation of the join, the inner table is the table on the right
partition key for a range-partitioned table—one or more columns of the range-partitioned table in which values in the one or more columns are used to partition the range-partitioned table
join key for a table—one or more columns of the table involved in a join predicate
a data stream from a table is dammed—when an operation applied to the data stream requires the operation to be applied to all data in the stream before another operation can be applied to the data stream
a data stream from a table is piped—when the data stream is not dammed
partition elimination bitmap for a range-partitioned table—a set of bits with each bit representing a partition of the range-partitioned table, where a bit value of 0 infers that the partition corresponding to the bit need not be scanned and a bit value of 1 infers that the partition corresponding to the bit needs to be scanned

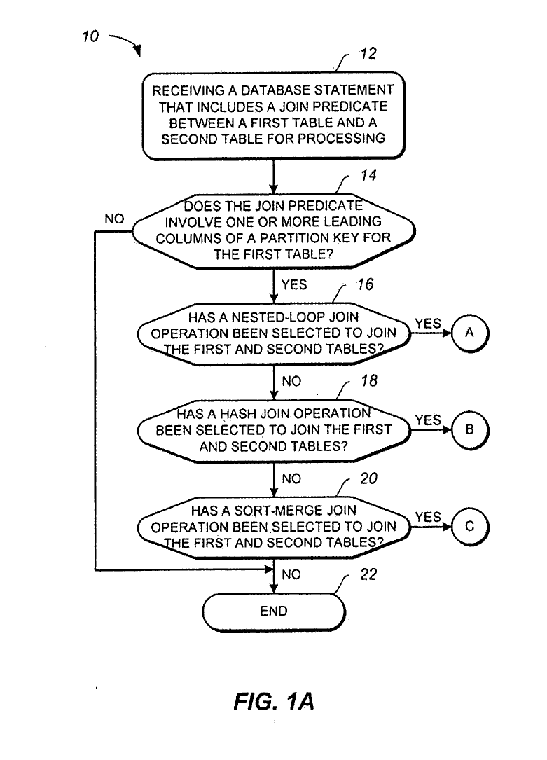

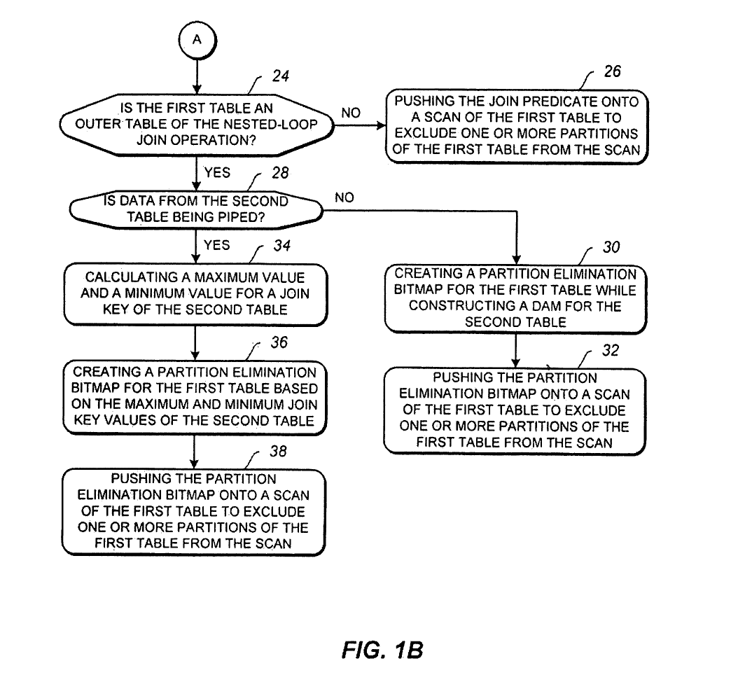

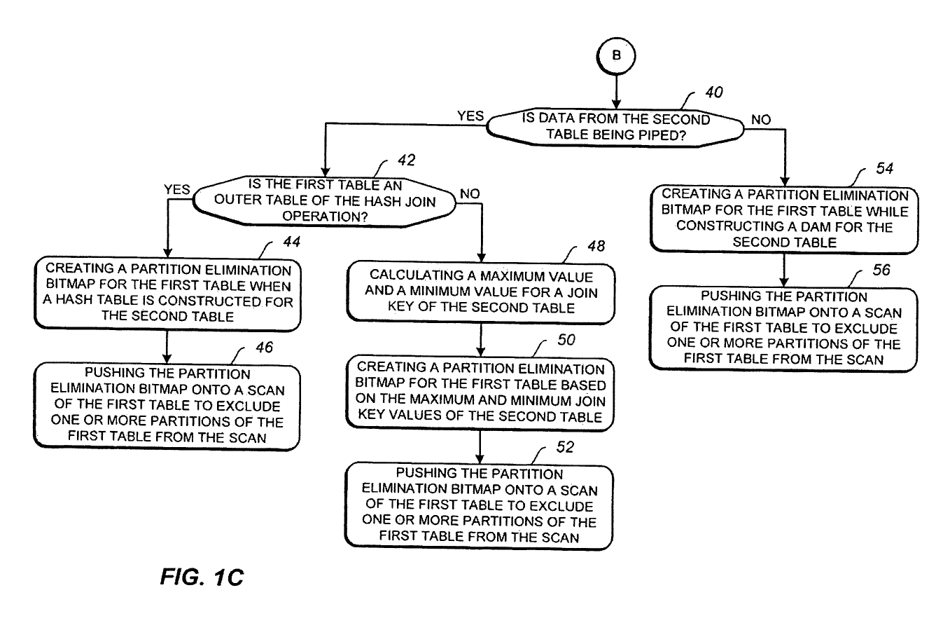

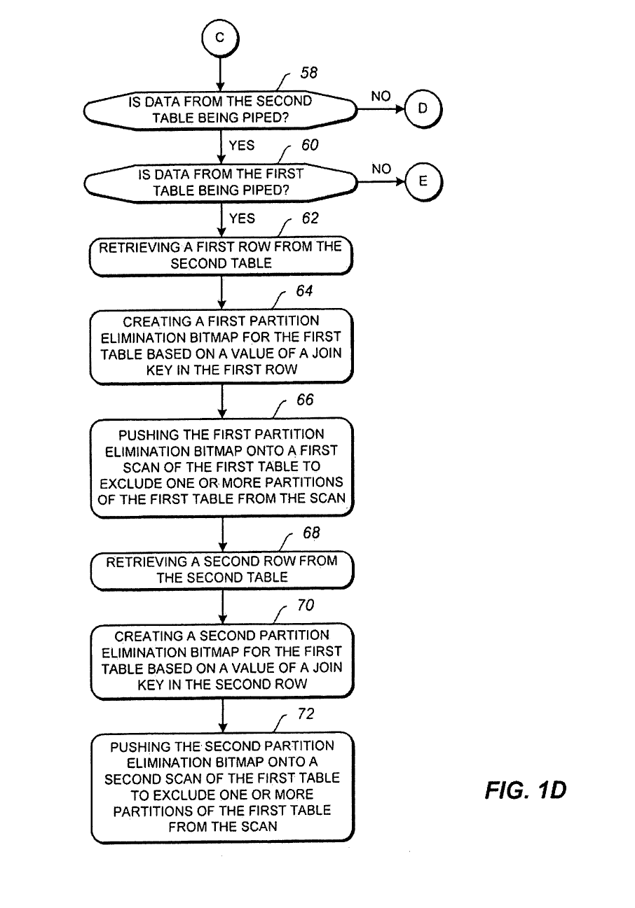

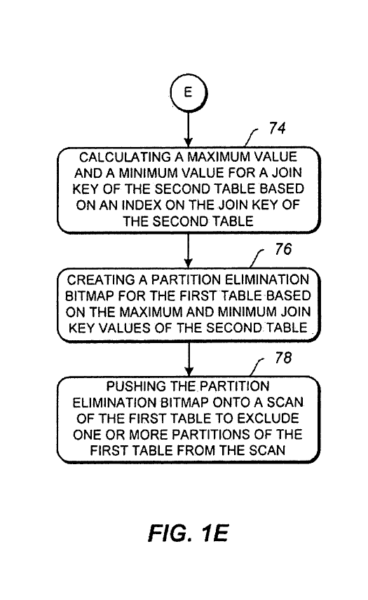

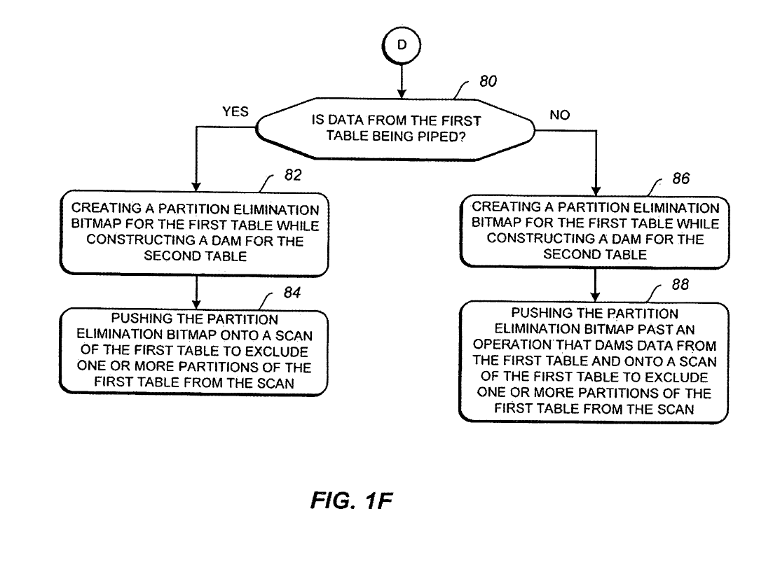

Depicted in FIGS. 1A-1F is a process 10 for processing database statements with join predicates on range-partitioned tables according to an implementation of the invention. At 12, a database statement is received for processing. The database statement includes a join predicate between a first table and a second table. In the implementation, the first table is a range-partitioned table that is partitioned based on values in a partition key of the first table.

At 14, a determination is made as to whether the join predicate involves one or more leading columns of the partition key for the first table. As an example, suppose the partition key for the first table is columns A, B, and C. If the join predicate involves column A of the first table, columns A and B of the first table, or columns A, B, and C of the first table, then the join predicate involves one or more leading columns of the partition key for the first table.

If it is determined at 14 that the join predicate does not involve one or more leading columns of the partition key for the first table (e.g., join predicate only involves columns B and/or C), then process 10 ends at 22. Otherwise, a determination is made at 16 as to whether a nested-loop join operation has been selected to join the first table and the second table. When a nested-loop join operation has been selected to join the first table and the second table, process 10 proceeds to process block 24 in FIG. 1B.

At 24 in FIG. 1B, a determination is made as to whether the first table is an outer table of the nested-loop join operation. If the first table is not the outer table of the nested-loop join operation (i.e., the first table is an inner table of the nested-loop join operation), then the join predicate is pushed onto a scan of the first table at 26 to exclude one or more partitions of the first table from the scan of the first table.

However, if the first table is the outer table of the nested-loop join operation, then a determination is made at 28 as to whether data from the second table is being piped. When data from the second table is not being piped (i.e., data from the second table is being dammed), a partition elimination bitmap is created for the first table at 30 while constructing a dam for the second table. At 32, the partition elimination bitmap created for the first table is pushed onto a scan of the first table to exclude one or more partitions of the first table from the scan.

In one implementation, the second table is a derived table (e.g., a table derived from other operations, such as one or more filtering operations, other join operations, and so forth). Hence, the partition elimination bitmap may not be created for the first table until a last dam before the nested-loop join operation is being constructed. Specifically, more than one dam may be constructed depending on the type and number of operations leading to the derivation of the second table.

Referring back to FIG. 1B, if it is determined at 28 that data from the second table is being piped, then at 34, a maximum value and a minimum value of a join key for the second table are calculated. An index on the second table may be used to calculate the maximum and minimum join key values for the second table. At 36, a partition elimination bitmap is created for the first table based on the maximum value and the minimum value calculated for the join key of the second table. At 38, the partition elimination bitmap created for the first table is pushed onto a scan of the first table to exclude one or more partitions of the first table from the scan.

For example, suppose a first table ‘RP’ is partitioned on columns ‘a’ and ‘b’ and includes the following partitions:

| Partition ID | Starting Values (a, b) | Ending Values (a, b) |
|---|---|---|
| 0 | (0, 0) | (0, 499) |
| 1 | (0, 500) | (0, 999) |
| 2 | (1, 0) | (1, 499) |
| 3 | (1, 500) | (1, 999) |
| 4 | (2, 0) | (2, 499) |
| 5 | (2, 500) | (2, 999) |
| 6 | (3, 0) | (3, 499) |
| 7 | (3, 500) | (3, 999) |

In addition, suppose a second table ‘TT’ with columns ‘a’ and ‘b’ includes the following values:

```
(1, 1)
(1, 2)
. . .
  (1, 400)
(3, 1)
(3, 2)
. . .
    (3, 1000)
```

Also, suppose a database statement received for processing includes the following two join predicates:
Predicate 1: TT.a=RP.a
Predicate 2: TT.b=RP.b

Given the above assumptions, the join key for the second table ‘TT’ is (a, b), the minimum value for the join key of the second table ‘TT’ is (1, 1), and the maximum values for the join key of the second table ‘TT’ is (3, 1000). A partition elimination bitmap of [00111111] can then be created for the first table ‘RP’ based on the maximum and minimum join key values of the second table ‘TT’. Partitions 0 and 1 of the first table ‘RP’ will not be scanned because both the starting and ending values of those partitions are below the minimum join key value of the second table ‘TT’. As a result, none of the data in partitions 0 and 1 of the first table ‘RP’ will satisfy the two join predicates.

In one implementation, process 10 includes an additional process block (not shown) between process blocks 28 and 34 in which a determination is made as to whether a cost associated with calculating the maximum and minimum join key values of the second table will be less than a cost associated with scanning one or more partitions of the first table. For instance, the cost associated with calculating the maximum and minimum join key values of the second table may be more if an index has not been created on the join key of the second table.

If the cost associated with calculating the maximum and minimum values for the join key of the second table will be less than the cost associated with scanning one or more partitions of the first table, then process 10 proceeds to process block 34. Otherwise, process 10 ends at 22 because it will be inefficient to go through process blocks 34 through 38 when it will be less costly to simply scan all of the partitions of the first table.

Referring back to FIG. 1A, if it is determined at 16 that a nested-loop join operation has not been selected to join the first table and the second table, then a determination is made at 18 as to whether a hash join operation has been selected to join the first table and the second table. If a hash join operation has been selected to join the first table and the second table, then process 10 proceeds to process block 40 in FIG. 1C.

With a hash join operation, a hash table is constructed for a table that is designated as an inner table of the hash join operation. When constructing the hash table, the inner table is scanned and rows of the inner table are copied into memory buffers. The memory buffers are then divided into sections based on hash values computed on a join key of the inner table. If the size of the inner table exceeds the memory available for buffering, buffers from selected sections may be written to temporary tables.

After the inner table has been processed, the table designated as an outer table of the hash join operation is scanned and rows from the outer table are matched to rows from the inner table by comparing hash values computed on join keys of the inner and outer tables. If the hash value on the join key of a row from the outer table matches the hash value on the join key of a row from the inner table, then the actual join key value of the row from the outer table is compared to the actual join key value of the row from the inner table.

Rows from the outer table that correspond to portions of the inner table not written to a temporary table are match immediately with rows from the inner table that are in memory. If the portion of the inner table corresponding to a row from the outer table was written to a temporary table, then the row from the outer table is also written to a temporary table. Subsequently, matching pairs of table portions from temporary tables are read, hash values are matched, and join predicates are checked.

In FIG. 1C, a determination is made at 40 as to whether data from the second table is being piped. If data from the second table is being piped, then a determination is made at 42 as to whether the first table is an outer table of the hash join operation. When the first table is the outer table of the hash join operation, a partition elimination bitmap is created for the first table at 44 when a hash table is constructed for the second table. Since the entire second table, which is the inner table of the hash join operation, will be copied into memory buffers to construct the hash table before the first table, which is the outer table of the hash join operation, is processed, all values in the first table that will need to be accessed will be known. At 46, the partition elimination bitmap created for the first table is pushed onto a scan of the first table to exclude one or more partitions of the first table from the scan.

On the other hand, when the first table is the inner table of the hash join operation, a maximum value and a minimum value of the join key for the second table are calculated at 48. The maximum and minimum values may be calculated using an index on the join key of the second table. A partition elimination bitmap is created for the first table based on the maximum and minimum join key values calculated for the second table at 50. The partition elimination bitmap created for the first table is then pushed onto a scan of the first table to exclude one or more partitions of the first table from the scan at 52.

In one implementation, process 10 includes an additional process block (not shown) between process blocks 46 and 48 in which a determination is made as to whether a cost associated with calculating the maximum and minimum join key values of the second table will be less than a cost associated with scanning one or more partitions of the first table. For instance, the cost associated with calculating the maximum and minimum join key values of the second table may be more if an index has not been created on the join key of the second table.

If the cost associated with calculating the maximum and minimum values for the join key of the second table will be less than the cost associated with scanning one or more partitions of the first table, then process 10 proceeds to process block 48. Otherwise, process 10 ends at 22 because it will be inefficient to go through process blocks 48 through 52 when it will be less costly to simply scan all of the partitions of the first table.

Referring back to FIG. 1C, if it is determined at 40 that data from the second table is not being piped, then a partition elimination bitmap is created for the first table at 54 while a dam is constructed for the second table. At 56, the partition elimination bitmap created for the first table is pushed onto a scan of the first table to exclude one or more partitions of the first table from the scan. As previously noted, the second table may be a derived table and as such, the partition elimination bitmap may not be created for the first table until a last dam before the hash join operation is being constructed.

Referring back to FIG. 1A, if it is determined at 18 that a hash join operation has not been selected to join the first table and the second table, then a determination is made at 20 as to whether a sort-merge join operation has been selected to join the first table and the second table. Process 10 proceeds to process block 58 in FIG. 1D if a sort-merge join operation has been selected to join the first table and the second table. Otherwise, process 10 ends at 22.

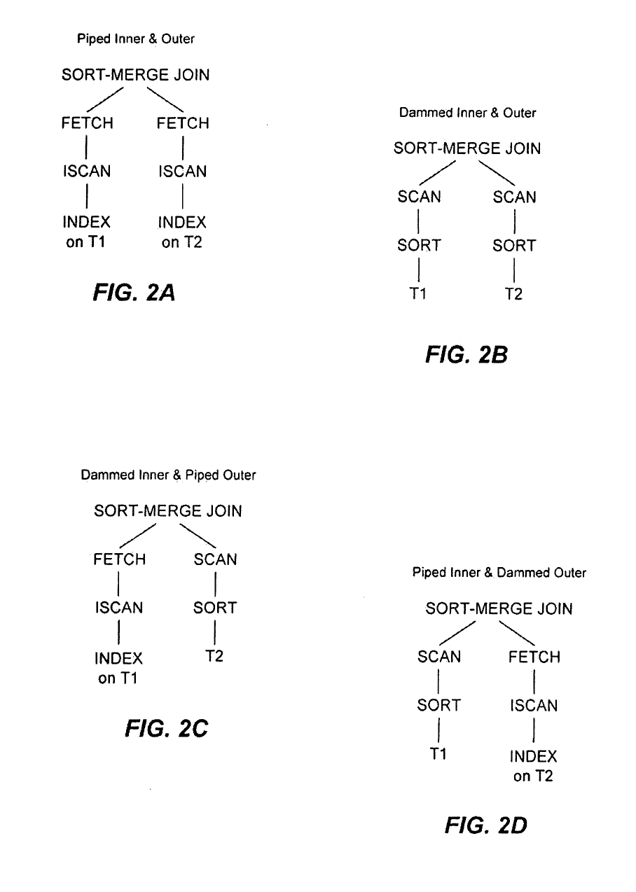

Graphical representations of different types of sort-merge join operations are illustrated in FIGS. 2A-2D. In each of FIGS. 2A-2D, a table ‘T1’ has been designated as an outer table of a sort-merge join operation and a table ‘T2’ has been designated as an inner table of the sort-merge join operation. As illustrated in FIG. 2A, when data streams from both tables ‘T1’ and ‘T2’ are piped, rows from each of the tables ‘T2’ and ‘T2’ are fetched in sorted order by scanning an index for each table.

In FIG. 2B, data streams from both tables ‘T1’ and ‘T2’ are dammed. Hence, each of the tables ‘T1’ and ‘T2’ is scanned and sorted. In FIG. 2C, data stream from outer table ‘T1’ is piped while data stream from inner table ‘T2’ is dammed. Whereas in FIG. 2D, data stream from outer table ‘T1’ is dammed while data stream from inner table ‘T2’ is piped. Other variations may be available where, for instance, table ‘T1’ is the inner table while table ‘T2’ is the outer table. Data streams from one or both of tables ‘T1’ and ‘T2’ may be derived (e.g., not limited to single tables).

At 58 in FIG. 1D, a determination is made as to whether data from the second table is being piped. When it is determined at 58 that data from the second table is being piped, a determination is made at 60 as to whether data from the first table is being piped. If it is determined at 60 that data from both the first table and the second table are being piped, then at 62, a first row is retrieved from the second table. A first partition elimination bitmap is created for the first table at 64 based on a value of a join key in the first row retrieved from the second table. The first partition elimination bitmap is pushed onto a first scan of the first table at 66 to exclude one or more partitions of the first table from the first scan.

A second row is retrieved from the second table at 68. At 70, a second partition elimination bitmap is created for the first table based on a value of a join key in the second row retrieved from the second table. The second partition elimination bitmap is then pushed onto a second scan of the first table at 72 to exclude one or more partitions of the first table from the second scan.

In one implementation, creation of the partition elimination bitmaps for the first table comprises preparing a sorted partition identifiers list for the first table. In the sorted partition identifiers list, identifiers for partitions of the first table are sorted based on values of the partition key for the first table. For example, suppose data from both the inner table and the outer table of a sort-merge operation are being piped. In addition, suppose the inner table is a range-partitioned table that includes 3 partitions identified as P0, P1, and P2, which are partitioned based on values in one column of the inner table. The one column is both a partition key and a join key for the inner table. Also, suppose the partition key value ranges for the 3 partitions of the inner table are defined as follows:
P0: values starting from 100 and ending in 199
P1: values starting from 0 and ending in 99
P2: values starting from 400 and ending in 499

The sorted partition identifiers list for the inner table would then be {P1, P0, P2}. Once the sorted partition identifiers list for the first table has been prepared, an initial partition elimination bitmap is created for the first table with all partitions to be scanned. Hence, in the example above, the initial partition elimination bitmap for the inner table would be [111], which represents partitions P0, P1, and P2 in non-sorted order.

Based on the join key value of a particular row fetched from the second table, one or more partitions in the first table that include the particular join key value are identified. The sorted partition identifiers list for the first table can then be used to identify any partition in the first table preceding the one or more partitions that include the join key value of the particular row. The initial partition elimination bitmap can then be updated so that the preceding partitions identified will not be scanned.

In the example above, suppose a row retrieved from the outer table of the sort-merge join operation has a join key value of 151. Partition P0 in the inner table will then be identified as including the join key value of the row retrieved from the outer table. Based on the sorted partition identifiers list for the inner table, partition P1 precedes partition P0. As a result, the initial partition elimination bitmap for the inner table will be updated to [101] to reflect that partition P1 of the inner table need not be accessed.

Rows that are retrieved from the second table after the very first row is retrieved need not use the initial partition elimination bitmap since rows in the second table will be retrieved in sorted order. Thus, creating a partition elimination bitmap for a row retrieved from the second table may only involve updating a partition elimination bitmap created for a row previously retrieved from the second table, or may simply involve utilizing the partition elimination bitmap created for the row previously retrieved from the second table.

For instance, in the example above, suppose a next row retrieved from the outer table of the sort-merge join operation has a join key value of 199. The partition elimination bitmap [101] created for the inner table based on the row previously retrieved from the outer table can be reused since partition P0 in the inner table also includes the join key value of the next row retrieved from the outer table.

Suppose, in the example above, a third row retrieved from the outer table of the sort-merge join operation has a join key value of 450. Partition P2 will be identified as including the join key value of the third row retrieved from the outer table. Based on the sorted partition identifiers list for the inner table, partitions P1 and P0 both precede partition P2. As a result, the partition elimination bitmap [101] created for the inner table based on the second row retrieved will be updated to [001] to reflect that partitions P0 and P1 of the inner table need not be accessed.

Although FIG. 1D only depicts the retrieval of two rows from the second table and the creation of a partition elimination bitmap for the first table with respect to each of the two rows retrieved from the second table, the process of retrieving a row from the second table and creating a partition elimination bitmap for the first table based on a value of a join key in the row retrieved from the second table can be applied to more than two rows of the second table. For instance, the process may be applied to all rows in the second table.

If it is determined at 60 in FIG. 1D that data from the first table is not being piped, then process 10 proceeds to process block 74 in FIG. 1E. At 74, a maximum value and a minimum value for a join key of the second table are calculated using an index on the join key of the second table. When a table is piped, it is implied that there is an index on a join key of the table since access to the table has no damming operations. At 76, a partition elimination bitmap is created for the first table based on the maximum and minimum join key values calculated for the second table. The partition elimination bitmap created for the first table is pushed onto a scan of the first table at 78 to exclude one or more partitions of the first table from the scan.

If it is determined at 58 in FIG. 1D that data from the second table is not being piped, then process 10 proceeds to process block 80 in FIG. 1F. In FIG. 1F, a determination is made at 80 as to whether data from the first table is being piped. If data from the first table is being piped when data from the second table is being dammed, then at 82, a partition elimination bitmap is created for the first table while a dam is constructed for the second table. Since the second table may be a derived table, the partition elimination bitmap may not be created for the first table until a last dam before the sort-merge join operation is being constructed. The partition elimination bitmap created for the first table is then pushed onto a scan of the first table at 84 to exclude one or more partitions of the first table from the scan.

On the other hand, if it is determined at 80 that data from the first table is not being piped (i.e., data from the first table is being dammed), then a partition elimination bitmap is created for the first table at 86 while a dam is constructed for the second table. In one implementation, the second table is a derived table and the partition elimination bitmap is not created for the first table until a last dam before the sort-merge join operation is being constructed. At 88, the partition elimination bitmap created for the first table is pushed past an operation that dams data from the first table and onto a scan of the first table to exclude one or more partitions of the first table from being scanned.

The techniques discussed above in FIGS. 1A-1F may be used simultaneously when both the first table and the second table are range-partitioned tables. For example, if a hash join operation has been selected to join an inner table and an outer table that are both range-partitioned tables, process blocks 42-44 in FIG. 1C can be applied to the outer table and process blocks 46-56 in FIG. 1C can be applied to the inner table.

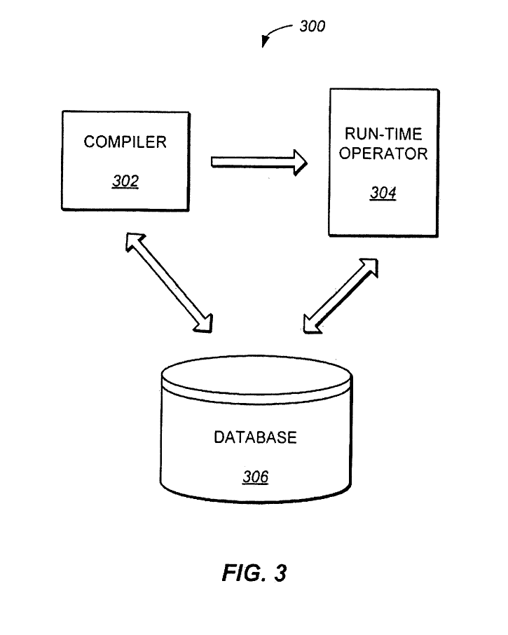

FIG. 3 illustrates a system 300 for processing database statements with join predicates on range-partitioned tables according to an implementation of the invention. System 300 includes a compiler 302 in communication with a run-time operator 304. A database 306 storing data, such as tables, views, and so forth, is also included in system 300. Other components (not shown) may be included in system 300. Additionally, compiler 302 and run-time operator 304 may each include sub-components (not shown). In one implementation, the process blocks of process 10 in FIGS. 1A-1F are performed by compiler 302 in conjunction with run-time operator 304.

Through aspects of the present invention, data partition elimination is now possible even when a join predicate on a partitioning key of a range-partitioned table cannot be pushed down onto the scan of the range-partitioned table. Hence, even if a sort-merge join operation or a hash join operation is selected for optimization of a database statement that includes a join predicate on a range-partitioned table or a nested-loop join operation with the range-partitioned table as the outer table is selected for optimization of the database statement, partitions of the range-partitioned table that will not satisfy the join predicate can be eliminated from processing.

The invention can take the form of an entirely hardware implementation, an entirely software implementation, or an implementation containing both hardware and software elements. In one aspect, the invention is implemented in software, which includes, but is not limited to, application software, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

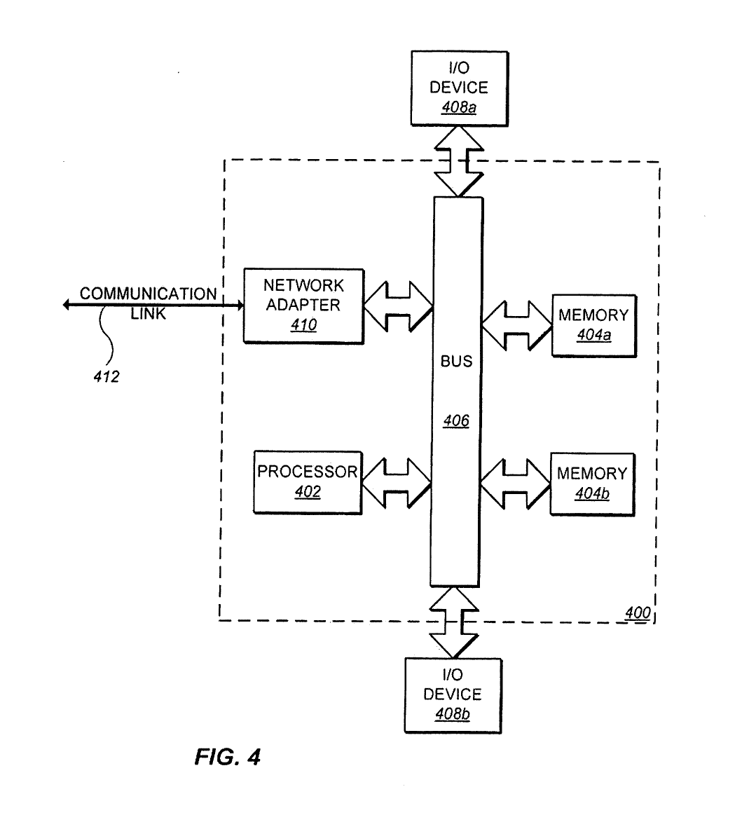

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

While various implementations for processing of database statements with join predicates on range-partitioned tables have been described, the technical scope of the present invention is not limited thereto. For example, the present invention is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of the present invention.

What is claimed is:

1. A method for processing database statements with join predicates on range-partitioned tables, the method comprising:
receiving a database statement for processing, the database statement comprising a join predicate between a first table and a second table, the first table being a range-partitioned table that is partitioned based on values in a partition key of the first table, the partition key of the first table being one or more columns of the first table;
responsive to the join predicate involving one or more leading columns of the partition key for the first table, determining whether a nested-loop join operation, a sort-merge join operation, or a hash join operation has been selected to join the first table and the second table;
responsive to a nested-loop join operation being selected to join the first table and the second table,
determining whether the first table is an outer table or an inner table of the nested-loop join operation;
responsive to the first table being the outer table of the nested-loop join operation,
determining whether data from the second table is being piped or dammed;
responsive to data from the second table being piped,
calculating a maximum value and a minimum value for a join key of the second table, the join key of the second table being one or more columns of the second table involved in the join predicate,
creating a partition elimination bitmap for the first table based on the maximum value and the minimum value calculated for the join key of the second table, the partition elimination bitmap including a bit for each partition in the first table, a value of each bit in the partition elimination bitmap denoting whether the partition in the first table corresponding to the bit is to be scanned or not, and
pushing the partition elimination bitmap created for the first table onto a scan of the first table to exclude one or more partitions of the first table from the scan;
responsive to data from the second table being dammed,
creating a partition elimination bitmap for the first table while constructing a dam for the second table, and
pushing the partition elimination bitmap created for the first table onto a scan of the first table to exclude one or more partitions of the first table from the scan; and
responsive to the first table being the inner table of the nested-loop join operation,
pushing the join predicate onto a scan of the first table to exclude one or more partitions of the first table from the scan of the first table.

2. The method of claim 1, wherein responsive to a hash join operation being selected to join the first table and the second table, the method further comprises:
determining whether data from the second table is being piped;
responsive to data from the second table being piped,
determining whether the first table is an outer table or an inner table of the hash join operation;
responsive to the first table being the outer table of the hash join operation,
creating a partition elimination bitmap for the first table when a hash table is constructed for the second table, and
pushing the partition elimination bitmap created for the first table onto a scan of the first table to exclude one or more partitions of the first table from the scan;
responsive to the first table being the inner table of the hash join operation,
calculating a maximum value and a minimum value for the join key of the second table,
creating a partition elimination bitmap for the first table based on the maximum value and the minimum value calculated for the join key of the second table, and
pushing the partition elimination bitmap created for the first table onto a scan of the first table to exclude one or more partitions of the first table from the scan; and
responsive to data from the second table being dammed,
creating a partition elimination bitmap for the first table while constructing a dam for the second table, and
pushing the partition elimination bitmap created for the first table onto a scan of the first table to exclude one or more partitions of the first table from the scan.

3. The method of claim 1, wherein responsive to a sort-merge join operation being selected to join the first table and the second table, the method further comprises:
determining whether data from the second table is being piped or dammed;
responsive to data from the second table being piped,
determining whether data from the first table is being piped or dammed;
responsive to data from the first table being piped,
retrieving a first row from the second table,
creating a first partition elimination bitmap for the first table based on a value of a join key in the first row retrieved from the second table,
pushing the first partition elimination bitmap onto a first scan of the first table to exclude one or more partitions of the first table from the first scan,
retrieving a second row from the second table,
creating a second partition elimination bitmap for the first table based on a value of a join key in the second row retrieved from the second table, and
pushing the second partition elimination bitmap onto a second scan of the first table to exclude one or more partitions of the first table from the second scan;
responsive to data from the first table being dammed,
calculating a maximum value and a minimum value for a join key of the second table based on an index on the join key of the second table,
creating a partition elimination bitmap for the first table based on the maximum value and the minimum value calculated for the join key of the second table, and
pushing the partition elimination bitmap created for the first table onto a scan of the first table to exclude one or more partitions of the first table from the scan;
responsive to data from the second table being dammed,
determining whether data from the first table is being piped or dammed;
responsive to data from the first table being piped,
creating a partition elimination bitmap for the first table while constructing a dam for the second table, and
pushing the partition elimination bitmap created for the first table onto a scan of the first table to exclude one or more partitions of the first table from the scan;
responsive to data from the first table being dammed,
creating a partition elimination bitmap for the first table while constructing a dam for the second table, and
pushing the partition elimination bitmap created for the first table past an operation damming data from the first table and onto a scan of the first table to exclude one or more partitions of the first table from the scan;

4. The method of claim 3, wherein creating the second partition elimination bitmap for the first table comprises:
updating the first partition elimination bitmap based on the value of the join key in the second row retrieved from the second table to create the second partition elimination bitmap.

5. The method of claim 1, wherein the second table is a derived table.

6. The method of claim 1, wherein the second table is a range-partitioned table.
